(19) United States
(12) Patent Application Publication
(10) Pub. No.: US 2019/0179299 A1
(43) Pub. Date: Jun. 13, 2019

(54) Hydrocyclone Wear Maintenance Control System

(71) Applicant: FLSmidth A/S, Valby (DK)

(72) Inventors: Jon Robert Culbertson, Oro Valley, AZ (US); David Allen Taylor, Salt Lake City, UT (US)

(21) Appl. No.: 16/324,337

(22) PCT Filed: Aug. 1, 2017
(86) PCT No.: PCT/IB2017/054684

§ 371 Date: Feb. 8, 2019

Related U.S. Application Data
(60) Provisional application No. 62/373,229, filed on Aug. 10, 2016.

(51) Int. Cl. G05B 23/02

(52) U.S. Cl. CPC G05B 23/0283; B04C 11/00; G05B 23/0289

(57) ABSTRACT

A new and improved hydrocyclone wear maintenance control system for managing wear maintenance among a plurality of hydrocyclone separators and method for its use are provided. The system includes one or more usage measurement devices and one or more electronic wear sensors disposed in communication with one or more hydrocyclone separators, along with a computer algorithm operable for recognizing a predetermined hydrocyclone maintenance plan based on an end-user assessment and input to achieve a preferred or optimal schedule, estimated wear, analyzing slurry flow time data and wear condition data for calculating an estimated wear profile, automatically directing said hydrocyclone control system to activate and deactivate one or more hydrocyclone separators as necessary to follow the predetermined hydrocyclone maintenance plan, calculating a subsequent estimated wear profile based on further analysis, and allowing adjustments to be made to the predetermined hydrocyclone maintenance plan based on the subsequently estimated wear profile. The system and method provide for improved wear maintenance scheduling.

### CROSS-REFERENCE TO RELATED APPLICATIONS

This is an International Application which claims the benefit of U.S. Provisional Patent Application No. 62/373,229, filed 10 Aug. 2016, the contents of which are hereby incorporated by reference, in its entirety, for any and all purposes, as if fully set forth herein.

### FIELD OF THE INVENTION

This invention pertains generally to the use of hydrocyclone separators for liquid/solid separation in the minerals processing, power and coal industries. In particular, it pertains to a control system and method including computer hardware, wear sensors, valve timers, process operation data and proprietary control software algorithms for automatically activating and deactivating individual or groups of hydrocyclone separators for actively controlling the wear of such hydrocyclone separators to produce a desired wear pattern for matching planned maintenance schedules.

### BACKGROUND OF THE INVENTION

Hydrocyclones used in the minerals processing, power and coal industries are exposed to flowing liquid/solid slurries that cause abrasive wear on interior wall surfaces of the separation chamber and inlet/outlet ports. Excessive amounts of wear can result in unacceptably high circulation loads within the separation circuit, and which can result in poor separation efficiency. For these reasons, hydrocyclones require periodic maintenance to repair and/or replace components subject to wear, including both individual hydrocyclone sections and applied interior surface wear liners. The need for such maintenance results in downtime for individual hydrocyclone units and manifold systems comprising groups of individual hydrocyclone units, which can slow or stop the desired production process. When this maintenance can be performed on a planned schedule, the downtime, inconvenience, effort and cost associated with the maintenance is reduced, time and cost budgeting and predictability are improved, overall process visibility is enhanced and the maintenance can take advantage of available rebuild programs. Also, performing such maintenance at a time before wear is considered unacceptably high tends to reduce process upset conditions and prevent costly premature or unscheduled maintenance activities. In addition, having the ability to plan the maintenance of hydrocyclone groups is advantageous for further reducing the downtime, inconvenience, effort and cost associated with the maintenance, as well as for further improving time and cost budgeting and predictability, overall process visibility, and taking advantage of available rebuild programs.

Many facilities in the minerals processing, power and coal industries have manifold systems comprising groups of individual hydrocyclone units, so that some individual units or groups of units can be activated or deactivated at any given time with remotely actuated valves operated via dedicated computer workstation from a control room, or manual valves, based on separation process and maintenance requirements. Accordingly, at any given time, a facility may operate with less than all of its total hydrocyclone units active, some units being in a standby or maintenance condition, while still satisfying current separation process requirements. In addition to activate or deactivate, other parameters (discussed below) can be adjusted to control the operation, performance and wear of individual or groups of hydrocyclones, again based on separation process requirements.

Wear in hydrocyclones is typically detected and monitored in two ways: (1) through the use of timers, such as valve timers, that directly measure the amount of time a given hydrocyclone has been in operation, and (2) through the use of wear sensors embedded within liners of the cyclone walls or in areas of anticipated wear. The wear sensors communicate signals reporting the slow abrasion of the liner material during operation to corresponding node units for each cyclone via waterproof cables connecting the sensors to each cyclone's corresponding node control box. The node units, in turn, feed operating data to manifold controllers via suitable cable, where signal data is accumulated and transmitted at regular intervals to a dedicated control room computer workstation, as shown and described in Applicant's prior U.S. Pat. No. 6,945,098, and as reproduced in FIG. 1.

While timers and wear sensors do provide hydrocyclone operators with some degree of actual wear estimation in hydrocyclones individually, they do not provide an accurate estimate of hydrocyclone wear among hydrocyclone groups, nor are they used, either individually or in groups, for controlling wear among hydrocyclone groups, especially in an optimized manner. Accordingly, the present devices and methods do not provide much capability for controlling wear as needed for maintenance planning purposes; nor do they allow for customizable plans for wear maintenance based on the needs of a particular facility. This is especially true when considering groups of hydrocyclones within a manifold, wherein each individual unit might have different operating characteristics and history, such as different slurry compositions (including based on the material characteristics of the ore), different amounts of runtime, different introduced water dilution compositions, different operating pressures and different flowrates. For these reasons, it would be advantageous to have a better mechanism for actively estimating individual unit wear within a hydrocyclone group during its operation, to provide operators with the ability to actively, and preferably in an optimized manner, activate or deactivate individual or groups of hydrocyclones within a manifold to improve and plan wear distribution within the manifold, either more evenly or on an uneven basis to coincide with specific and preferred maintenance schedules.

For the above reasons, there exists a need for a hydrocyclone wear maintenance control system that is able to assist in the customizable activation and deactivation of individual or groups of hydrocyclones within a manifold, through detected timer, wear and other information, for facilitating a desired wear pattern among a hydrocyclone group and matching such wear pattern to a planned maintenance schedule for facilitating required wear maintenance. The subject matter disclosed herein at least partially satisfies this need.

### SUMMARY OF THE INVENTION

It is, in general, an object of the invention to provide a new and improved control system for optimally activating and deactivating individual or groups of hydrocyclone separators for controlling the wear of such hydrocyclone separators to produce a desired wear pattern and to match planned maintenance schedules, along with a method for its use. Furthermore, the invention allows for continuous monitoring of cyclone wear through direct and discrete sensors, as well as indirect estimation of wear from timers and sensors within the circuit that monitor overall process conditions. Another object of the invention is to provide a hydrocyclone wear maintenance control system and method of the above character that overcomes the limitations and disadvantages of the prior art.

These and other objects are achieved in accordance with the invention by providing a hydrocyclone wear maintenance control system for managing wear maintenance among a plurality of hydrocyclone separators, and disposed in communication with an associated hydrocyclone control system operable for monitoring and controlling operation of said plurality of hydrocyclone separators. In a preferred form, the control system comprises one or more usage measurement devices disposed in communication with one or more hydrocyclone separators, and operable for measuring and reporting slurry flow time data for one or more hydrocyclone separators; and one or more electronic wear sensors disposed in communication with an internal wear region of one or more hydrocyclone separators, and operable for detecting a wear condition within said internal wear region of said at least one hydrocyclone separator, creating electronic data indicative of said wear condition and reporting said electronic data indicative of said wear condition.

In this form, the control system further comprises a computer algorithm operable for recognizing a predetermined hydrocyclone maintenance plan based on an end-user assessment and user inputs establishing optimal or preferred plant maintenance schedules, estimated wear, analyzing the slurry flow time data and the wear condition data for one or more hydrocyclone separators, calculating an estimated wear profile for one or more hydrocyclone separators based on the analysis, automatically directing the hydrocyclone control system to activate and deactivate one or more hydrocyclone separators as necessary to follow the predetermined hydrocyclone maintenance plan, calculating a subsequent estimated wear profile for one or more hydrocyclone separators based on further analysis, and automatically or manually performing adjustments to the predetermined hydrocyclone maintenance plan based on the subsequently estimated wear profile.

These and other objects are also achieved in accordance with the invention by providing a method for managing wear maintenance among a plurality of hydrocyclone separators. In a preferred form, the method includes the steps of providing at least one usage measurement device disposed in communication with at least one hydrocyclone separator (not shown), and operable for measuring and reporting slurry flow time data for one or more hydrocyclone separators; and providing one or more electronic wear sensors disposed in communication with an internal wear region of one or more hydrocyclone separators, and operable for detecting a wear condition within the internal wear region of one or more hydrocyclone separators, and creating electronic data indicative of the wear condition and reporting said electronic data indicative of the wear condition.

The method further includes providing a predetermined hydrocyclone maintenance plan based on user input (as described above), estimated wear; providing a computer algorithm operable for receiving the slurry flow time data and the electronic data indicative of the wear condition; employing the computer algorithm for analyzing the slurry flow time data and the wear condition data for each hydrocyclone separator; employing the computer algorithm for calculating an estimated wear profile for each hydrocyclone separator based on the analysis; employing the computer algorithm for directing the hydrocyclone control system to activate and deactivate each hydrocyclone separator as necessary to follow the predetermined hydrocyclone maintenance plan; employing the computer algorithm for calculating a subsequent estimated wear profile for each hydrocyclone separator based on further said analysis; and performing adjustments to the predetermined hydrocyclone maintenance plan based on the subsequently estimated wear profile.

These and other objects are also achieved in accordance with the invention by providing a method for managing wear maintenance among a plurality of hydrocyclone separators, wherein the steps of providing a predetermined hydrocyclone maintenance plan based on estimated wear; analyzing the slurry flow time data and the wear condition data for one or more hydrocyclone separators; calculating an estimated wear profile for one or more hydrocyclone separators based on the analysis; directing the hydrocyclone control system to activate and deactivate one or more hydrocyclone separators as necessary to follow the predetermined hydrocyclone maintenance plan; calculating a subsequent estimated wear profile for one or more hydrocyclone separators based on further analysis; and allowing adjustments to be made to the predetermined hydrocyclone maintenance plan based on the subsequently estimated wear profile are performed by a computer algorithm operable for recognizing the predetermined hydrocyclone maintenance plan and performing each of the steps.

### BRIEF DESCRIPTION OF THE DRAWINGS

FIG. 1 is a schematic diagram showing the use of wired hydrocyclone wear sensors and their control environment according to the prior art.

FIG. 2 is a process diagram showing the components and method steps of the present invention.

FIG. 3 is a contribution diagram showing the various sensor and detector inputs whose data may be evaluated by the present hydrocyclone wear maintenance control system in controlling hydrocyclone activity.

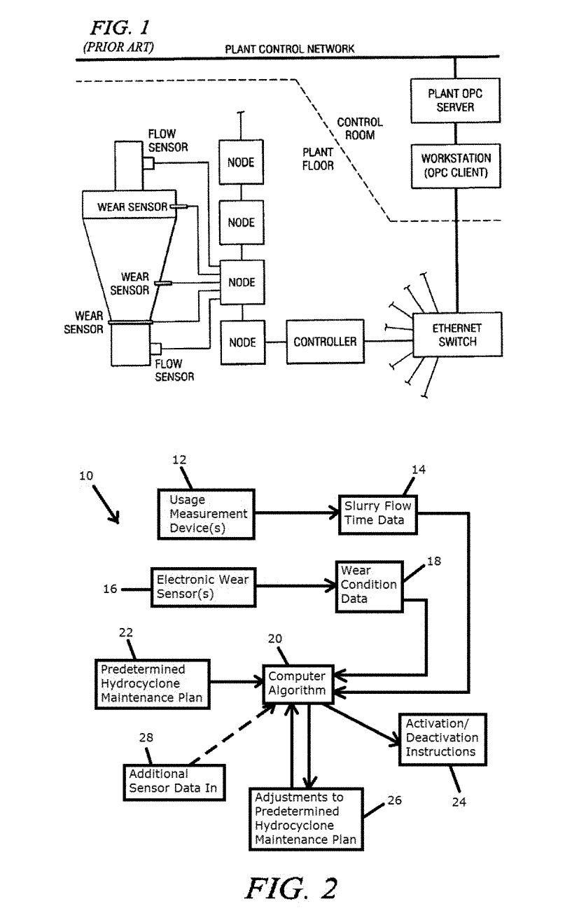

### DETAILED DESCRIPTION OF THE INVENTION

In accordance with the present invention, a hydrocyclone wear maintenance control system is provided that is capable of directing activation and deactivation, by an associated hydrocyclone control system, of individual or groups of hydrocyclone separators for controlling the wear of such hydrocyclone separators to produce a desired wear pattern and to match planned maintenance schedules, along with a method for its use. As shown in FIG. 2, the system 10 includes one or more usage measurement devices 12 disposed in communication with one or more hydrocyclone separators (not shown). The usage measurement devices 12 are capable of measuring and reporting slurry flow time data 14 through the hydrocyclone separator(s), either continuously or periodically during operation. Typical selections for the usage measurement devices 12 are valve timers and manifold valve position sensors, and these devices provide some estimation of internal hydrocyclone wear by directly measuring the amount of time a given hydrocyclone has been in operation.

The system 10 further includes one or more electronic wear sensors 16 disposed in communication with internal wear region(s) of one or more hydrocyclone separators (again, not shown). The electronic wear sensors 16 are capable of detecting a wear condition within the internal wear region(s) of the hydrocyclone separator(s), creating electronic data indicative of a wear condition 18 and reporting the electronic data indicative of a wear condition 18.

The system 10 further includes a computer algorithm 20 operable for recognizing a predetermined hydrocyclone maintenance plan 22 based on estimated wear and maintenance needs of the particular facility involved. The predetermined hydrocyclone maintenance plan 22 may preferably include a schedule for downtime of selected individual or groups of hydrocyclones for replacement of individual hydrocyclone sections and/or applied interior surface wear liners of the type that are typically subjected to wear, along with any other hydrocyclone components that might require maintenance, including inflow and outflow ports, pumps, flow meters, sensors and other associated devices. Preferably, the hydrocyclone maintenance plan 22 includes a schedule for activating and deactivating individual or groups of hydrocyclones within a manifold to improve and plan wear distribution within the manifold, either more evenly or on an uneven, but planned, basis. Such a schedule provides the ability to plan the maintenance of hydrocyclone groups for reducing the downtime, inconvenience, effort and cost associated with required maintenance, as well as for improving time and cost budgeting and predictability, overall process visibility, and taking advantage of available rebuild programs.

Slurry flow time data 14 generated and provided by the usage measurement device(s) 12 for the hydrocyclone(s) is provided to, and analyzed by, the computer algorithm 20. At the same time, wear condition data 18 generated and provided by the electronic wear sensor(s) 16 is also provided to, and analyzed by, the computer algorithm 20. With this data, the computer algorithm 20 is able to calculate an estimated wear profile for each hydrocyclone separator under consideration, and automatically direct the associated hydrocyclone control system (not shown, but typically including a dedicated computer workstation), through instructions 24, to activate and deactivate one or more hydrocyclone separators as necessary or desired to follow the predetermined hydrocyclone maintenance plan. The computer algorithm 20 is also able to calculate a subsequent estimated wear profile for one or more hydrocyclone separators based on this analysis, to allow manual or automatic adjustments to be made to the predetermined hydrocyclone maintenance plan 26 based on subsequently estimated wear profiles.

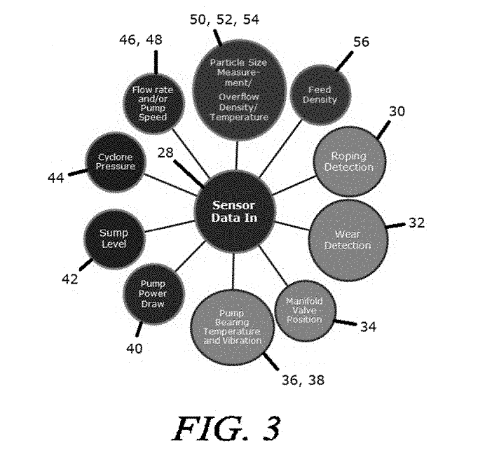

The predetermined hydrocyclone maintenance plan 22 may also take into account different operating characteristics and history, such as different slurry compositions, different amounts of runtime, different introduced water dilution compositions, different operating pressures and different flow rates, in directing activation or deactivation of one or more hydrocyclone separators, and also in developing adjustments to the predetermined hydrocyclone maintenance plan 26. More specifically, as shown in FIGS. 2 and 3, the computer algorithm 20 can also be provided with additional sensor data 28, representing either direct measurement or estimation of several process operation quantities associated with slurry flow through the hydrocyclone that may further assist the computer algorithm 20 in estimating wear conditions within individual or groups of hydrocyclone separators. This can be provided by one or more additional measurement devices that provide roping detection 30, wear detection 32 (previously described), manifold valve position 34 (previously described in terms of valve timing), feed pump bearing temperature 36, feed pump bearing vibration 38, feed pump power draw 40, water dilution sump level 42, hydrocyclone feed or internal pressure 44, hydrocyclone flow rate 46, feed pump speed 48, slurry particle size measurement 50, hydrocyclone overflow density 52, hydrocyclone overflow temperature 54, and slurry feed density 56.

Although measurement and estimation of these quantities does not necessarily predict hydrocyclone wear on its own, each operation quantity has a known or estimated influence of hydrocyclone wear, such that, when further combined together with wear condition and usage time data, can allow for more accurate predictions of actual hydrocyclone wear, its rate of wear, and its locations of wear. Accordingly, the inclusion of one or more of these additional data items may further assist the computer algorithm 20 in directing activation or deactivation of one or more hydrocyclone separators, and also in performing adjustments or allowing adjustments to be manually made to the predetermined hydrocyclone maintenance plan 26.

Accordingly, this novel invention uses the combination of timer-based wear prediction with proprietary catastrophic wear detection sensors, along with the optional use of additional operational data, to provide an unparalleled, fully-automated, configurable wear management solution. This information is valuable for allowing operators to predict when excessive wear occurs in individual or groups of hydrocyclone separators, and the rate at which such wear occurs, so that maintenance activities to replace hydrocyclone separator sections and/or liners can be planned in advance. In addition, this information is valuable for allowing operators to track the amount of time each individual unit is in operation, and to use this information, in combination with the data received from the various sensors, usage timers and wear detection devices, to turn individual or groups of hydrocyclone separators in a manifold on or off to regulate individual cyclone wear, to regulate cyclone wear in groups, and to produce uniform or non-uniform, but planned, wear among a hydrocyclone separator group. This active selection of hydrocyclone separators based on perceived wear life, allows operators to optimize wear and produce predictable maintenance schedules even more efficiently.

Through the present invention, wear patterns in hydrocyclone separators can be customized to meet the maintenance preference of the site. As an example, an operator can activate or deactivate groups of two or more cyclones in any desired combination so that the ideal number wear out together to optimize maintenance outages. Accordingly, the computer algorithm 20 operates as a background process and can be consistently reverted to, in its original or adjusted forms, after any process perturbation such as roping. The catastrophic failure model, which represents a direct measurement of wear, relies on its specialized sensors to determine when wear points have been achieved, and can be used to immediately shut-off cyclones as needed to prevent damage. When supplemented by the timer-based predictive model, the computer algorithm 20 is better able to adjust estimated wear life. When further supplemented by additional operational process data, the computer algorithm 20 provides even more improved estimates of wear life. The combination of the two primary control models, their customizable nature, and the automation provided to hydrocyclone control circuits are all novel developments in the field.

The present invention also provides a method of managing wear maintenance among one or more hydrocyclone separators. In a preferred form, the method comprises the steps of providing at least one usage measurement device 12 disposed in communication with at least one hydrocyclone separator (not shown), and operable for measuring and reporting slurry flow time data 14 for one or more hydrocyclone separators; and providing one or more electronic wear sensors 16 disposed in communication with an internal wear region of one or more hydrocyclone separators, and operable for detecting a wear condition within the internal wear region of one or more hydrocyclone separators, and creating electronic data indicative of the wear condition 18 and reporting said electronic data indicative of the wear condition 18.

The method further comprises providing a predetermined hydrocyclone maintenance plan 22 based on estimated wear; providing a computer algorithm 20 operable for receiving the slurry flow time data 14 and the electronic data indicative of the wear condition 18; employing the computer algorithm for analyzing the slurry flow time data 14 and the wear condition data 18 for each hydrocyclone separator; employing the computer algorithm 20 for calculating an estimated wear profile for each hydrocyclone separator based on the analysis; employing the computer algorithm 20 for directing the hydrocyclone control system to activate and deactivate each hydrocyclone separator as necessary to follow the predetermined hydrocyclone maintenance plan 22; employing the computer algorithm 20 for calculating a subsequent estimated wear profile for each hydrocyclone separator based on further said analysis; and allowing for adjustments to be made to the predetermined hydrocyclone maintenance plan 22 based on the subsequently estimated wear profile.

The disclosure of every patent, patent application, and publication cited herein is hereby incorporated herein by reference in its entirety.

While this subject matter has been disclosed with reference to specific embodiments, it is apparent that other embodiments and variations can be devised by others skilled in the art without departing from the true spirit and scope of the subject matter described herein. The appended claims include all such embodiments and equivalent variations.

1. A hydrocyclone wear maintenance control system for managing wear maintenance among a plurality of hydrocyclone separators, and disposed in communication with an associated hydrocyclone control system operable for monitoring and controlling operation of said plurality of hydrocyclone separators, comprising:
at least one usage measurement device disposed in communication with at least one hydrocyclone separator, and operable for measuring and reporting slurry flow time data through said at least one hydrocyclone separator;
at least one electronic wear sensor disposed in communication with an internal wear region of at least one hydrocyclone separator, and operable for detecting a wear condition within said internal wear region of said at least one hydrocyclone separator, creating electronic data indicative of said wear condition and reporting said electronic data indicative of said wear condition; and
a computer algorithm operable for recognizing a predetermined hydrocyclone maintenance plan based on estimated wear, analyzing said slurry flow time data and said wear condition data for said at least one hydrocyclone separator, calculating an estimated wear profile for said at least one hydrocyclone separator based on said analysis, automatically directing said hydrocyclone control system to activate and deactivate said at least one hydrocyclone separator as necessary to follow said predetermined hydrocyclone maintenance plan, calculating a subsequent estimated wear profile for said at least one hydrocyclone separator based on further said analysis, and allowing for adjustments to be made to said predetermined hydrocyclone maintenance plan based on said subsequently estimated wear profile.

2. The hydrocyclone wear maintenance control system according to claim 1, wherein said usage measurement device comprises at least one of a valve timer and a manifold valve position sensor.

3. The hydrocyclone wear maintenance control system according to claim 1, wherein said usage measurement device is operable for reporting said slurry flow time data for said at least one hydrocyclone separator continuously during operation of said at least one hydrocyclone separator.

4. The hydrocyclone wear maintenance control system according to claim 1, wherein said usage measurement device is operable for reporting said slurry flow time data for said at least one hydrocyclone separator periodically during operation of said at least one hydrocyclone separator.

5. The hydrocyclone wear maintenance control system according to claim 1, wherein said at least one electronic wear sensor is operable for detecting a wear condition within said internal wear region of said at least one hydrocyclone separator continuously during operation of said at least one hydrocyclone separator.

6. The hydrocyclone wear maintenance control system according to claim 1, wherein said at least one electronic wear sensor is operable for detecting a wear condition within said internal wear region of said at least one hydrocyclone separator periodically during operation of said at least one hydrocyclone separator.

7. The hydrocyclone wear maintenance control system according to claim 1, wherein said computer algorithm is operable for analyzing said slurry flow time data and said wear condition data for said at least one hydrocyclone separator, calculating an estimated wear profile for said at least one hydrocyclone separator based on said analysis, automatically directing said hydrocyclone control system to activate and deactivate said at least one hydrocyclone separator as necessary to follow said predetermined hydrocyclone maintenance plan, calculating a subsequent estimated wear profile for said at least one hydrocyclone separator based on further said analysis, and allowing adjustments to be made to said predetermined hydrocyclone maintenance plan based on said subsequently estimated wear profile, continuously during operation of said at least one hydrocyclone separator.

8. The hydrocyclone wear maintenance control system according to claim 1, wherein said computer algorithm is operable for analyzing said slurry flow time data and said wear condition data for said at least one hydrocyclone separator, calculating an estimated wear profile for said at least one hydrocyclone separator based on said analysis, automatically directing said hydrocyclone control system to activate and deactivate said at least one hydrocyclone separator as necessary to follow said predetermined hydrocyclone maintenance plan, calculating a subsequent estimated wear profile for said at least one hydrocyclone separator based on further said analysis, and allowing adjustments to be made to said predetermined hydrocyclone maintenance plan based on said subsequently estimated wear profile, periodically during operation of said at least one hydrocyclone separator.

9. The hydrocyclone wear maintenance control system according to claim 1, further comprising at least one additional measurement device operable for measuring and reporting an additional process operation quantity related to the operation of said at least one hydrocyclone separator, and wherein said computer algorithm is operable for further analyzing said additional process operation quantity and including said further analysis in calculating an estimated wear profile for said at least one hydrocyclone separator.

10. The hydrocyclone wear maintenance control system according to claim 9, wherein said at least one additional measurement device is selected from the group consisting of a roping condition detector, a feed pump bearing temperature sensor, a feed pump bearing vibration sensor, a feed pump power draw sensor, a water dilution sump level sensor, a hydrocyclone feed pressure sensor, an internal hydrocyclone pressure sensor, a slurry particle size measuring device, a hydrocyclone overflow density measuring device, a hydrocyclone overflow temperature sensor, and a slurry feed density measuring device.

11. The hydrocyclone wear maintenance control system according to claim 9, wherein said at least one additional measurement device comprises a plurality of devices selected from the group consisting of a roping condition detector, a feed pump bearing temperature sensor, a feed pump bearing vibration sensor, a feed pump power draw sensor, a water dilution sump level sensor, a hydrocyclone feed pressure sensor, an internal hydrocyclone pressure sensor, a slurry particle size measuring device, a hydrocyclone overflow density measuring device, a hydrocyclone overflow temperature sensor, and a slurry feed density measuring device.

12. A method for managing wear maintenance among a plurality of hydrocyclone separators comprising the steps of:
providing at least one usage measurement device disposed in communication with at least one hydrocyclone separator, and operable for measuring and reporting slurry flow time data for said at least one hydrocyclone separator;
providing at least one electronic wear sensor disposed in communication with an internal wear region of at least one hydrocyclone separator, and operable for detecting a wear condition within said internal wear region of said at least one hydrocyclone separator, creating electronic data indicative of said wear condition and reporting said electronic data indicative of said wear condition;
providing a predetermined hydrocyclone maintenance plan based on estimated wear;
analyzing said slurry flow time data and said wear condition data for said at least one hydrocyclone separator;
calculating an estimated wear profile for said at least one hydrocyclone separator based on said analysis;
directing said hydrocyclone control system to activate and deactivate said at least one hydrocyclone separator as necessary to follow said predetermined hydrocyclone maintenance plan;
calculating a subsequent estimated wear profile for said at least one hydrocyclone separator based on further said analysis; and
adjusting said predetermined hydrocyclone maintenance plan based on said subsequently estimated wear profile.

13. The method according to claim 12, further comprising the step of providing a computer algorithm operable for receiving said slurry flow time data and said electronic data indicative of said wear condition, wherein said steps of providing a predetermined hydrocyclone maintenance plan based on estimated wear; analyzing said slurry flow time data and said wear condition data for said at least one hydrocyclone separator; calculating an estimated wear profile for said at least one hydrocyclone separator based on said analysis; directing said hydrocyclone control system to activate and deactivate said at least one hydrocyclone separator as necessary to follow said predetermined hydrocyclone maintenance plan; calculating a subsequent estimated wear profile for said at least one hydrocyclone separator based on further said analysis; and adjusting said predetermined hydrocyclone maintenance plan based on said subsequently estimated wear profile are performed by said computer algorithm.

14. A method for managing wear maintenance among a plurality of hydrocyclone separators comprising the steps of:
providing at least one usage measurement device disposed in communication with each hydrocyclone separator, and operable for measuring and reporting slurry flow time data for each hydrocyclone separator;
providing at least one electronic wear sensor disposed in communication with an internal wear region of each hydrocyclone separator, and operable for detecting a wear condition within said internal wear region of each hydrocyclone separator, creating electronic data indicative of said wear condition and reporting said electronic data indicative of said wear condition;
providing a predetermined hydrocyclone maintenance plan based on estimated wear;
analyzing said slurry flow time data and said wear condition data for each hydrocyclone separator;
calculating an estimated wear profile for each hydrocyclone separator based on said analysis;
directing said hydrocyclone control system to activate and deactivate each hydrocyclone separator as necessary to follow said predetermined hydrocyclone maintenance plan;
calculating a subsequent estimated wear profile for each hydrocyclone separator based on further said analysis; and
allowing adjustments to be made to said predetermined hydrocyclone maintenance plan based on said subsequently estimated wear profile.

15. The method according to claim 14, further comprising the step of providing a computer algorithm operable for receiving said slurry flow time data and said electronic data indicative of said wear condition, wherein said steps of providing a predetermined hydrocyclone maintenance plan based on estimated wear; analyzing said slurry flow time data and said wear condition data for each hydrocyclone separator; calculating an estimated wear profile for each hydrocyclone separator based on said analysis; directing said hydrocyclone control system to activate and deactivate each hydrocyclone separator as necessary to follow said predetermined hydrocyclone maintenance plan; calculating a subsequent estimated wear profile for each hydrocyclone separator based on further said analysis; and adjusting said predetermined hydrocyclone maintenance plan based on said subsequently estimated wear profile are performed by said computer algorithm.

16. A method for managing wear maintenance among a plurality of hydrocyclone separators comprising the steps of:
providing at least one usage measurement device disposed in communication with each hydrocyclone separator, and operable for measuring and reporting slurry flow time data for each hydrocyclone separator;
providing at least one electronic wear sensor disposed in communication with an internal wear region of each hydrocyclone separator, and operable for detecting a wear condition within said internal wear region of each hydrocyclone separator, creating electronic data indicative of said wear condition and reporting said electronic data indicative of said wear condition;
providing a predetermined hydrocyclone maintenance plan based on estimated wear;
providing a computer algorithm operable for receiving said slurry flow time data and said electronic data indicative of said wear condition;
employing said computer algorithm for analyzing said slurry flow time data and said wear condition data for each hydrocyclone separator;
employing said computer algorithm for calculating an estimated wear profile for each hydrocyclone separator based on said analysis;
employing said computer algorithm for directing said hydrocyclone control system to activate and deactivate each hydrocyclone separator as necessary to follow said predetermined hydrocyclone maintenance plan;
employing said computer algorithm for calculating a subsequent estimated wear profile for each hydrocyclone separator based on further said analysis; and
performing adjustments to said predetermined hydrocyclone maintenance plan based on said subsequently estimated wear profile.
